(19) United States
(12) Patent Application Publication
(10) Pub. No.: US 2008/0276812 A1
(43) Pub. Date: Nov. 13, 2008

(54) Pressing Cyclinder, Preferably For Use In A Refuse Container

(76) Inventor: Kristian Skannerup, Ulfborg (DK)

Correspondence Address: DENNISON, SCHULTZ & MACDONALD, 1727 KING STREET, SUITE 105, ALEXANDRIA, VA, 22314, US

(21) Appl. No.: 10/580,980

(22) PCT Filed: Dec. 2, 2003
(86) PCT No.: PCT/DK03/00823

§ 371 Date: Jul. 21, 2006

(51) Int. Cl. B30B 1/00

(52) U.S. Cl. 100/226

(57) ABSTRACT

A pressing cylinder, preferably for use in a refuse compressor, which when in use is preferably in a vertical position, and at the bottom is coupled to a pressing plate and at the top to a secured top plate and which can activate the pressing plate in upward and downward directions, includes preferably three cylinder sections, a first, lower cylinder section which at the bottom is attached to the pressing plate, a second, intermediate cylinder section which can be displaced telescopically in the cylinder's longitudinal direction on the first cylinder section, and a third, upper cylinder section which at the top is attached to the top plate, and which can be displaced telescopically on the second cylinder section. The cylinder can have a large diameter and operate at a correspondingly low working pressure and can therefore have a small wall thickness or be produced of materials other than steel. The pressing cylinder consequently becomes light, easy to operate and cheap to produce.

The present invention relates to a refuse compressor of the kind described in the introductory part of claim 1.

The known refuse compressors use a double-acting hydraulic pressing cylinder. Such a pressing cylinder needs a long stroke corresponding to the travel of the pressing plate. As it furthermore operates at a high pressure the wall thickness of the cylinder will have to be great. The pressing cylinder therefore becomes large and heavy and difficult to handle, and consequently its use is limited to large recycling centres.

It is a purpose of the present invention to describe a pressing cylinder, which does not have the drawbacks of the known pressing cylinders.

This is achieved by embodying the pressing cylinder as described in the characterising part of claim 1. This will have the effect that the length of the cylinder in its unloaded position is essentially shorter that the cylinder's length of stroke. The cylinder can have a diameter which is approximately equal to the diameter of the pressing plate. As the cylinder therefore can operate at a lower working pressure, the cylinder can be constructed with a smaller wall thickness or of other materials lighter than steel, for example synthetic materials. The pressing cylinder therefore becomes light and easy to handle. Furthermore, production costs will be low.

Compression of refuse can therefore be spread to new user groups, which so far have been prevented from the facility on account of lack of availability of usable equipment. The use of the present invention will thus make it possible for ordinary households or smaller undertakings to use compression of domestic refuse and obtain an economically attractive and environmentally-friendly sorting-at-source of the refuse. The social advantage of this can give enormous savings in connection with collection of refuse from private households and firms. As the degree of compression of the refuse—depending on the type of refuse—is 65%-85%, the transportation in connection with collection will be correspondingly reduced.

Claim 2 describes preferred stop organs, which come to rest against each other in the extended position and limit the length of stroke.

By the embodiment described in claim 3 it is achieved that the individual cylinder sections for a pressing cylinder according to the invention cannot rotate in relation to each other.

Claim 4 relates to preferred means for attachment of a diaphragm to the pressing cylinder according to the invention.

Claim 5 describes the advantage of the fact that a torque acting on the cylinder sections by the turning of the windings in a spring is counter-acted by another spring.

Claim 6 describes the advantage of the fact that the spring can be taken up in the hollow space in the third cylinder section in the retracted position of the pressing cylinder.

The invention is explained in detail below with reference to the drawing in which

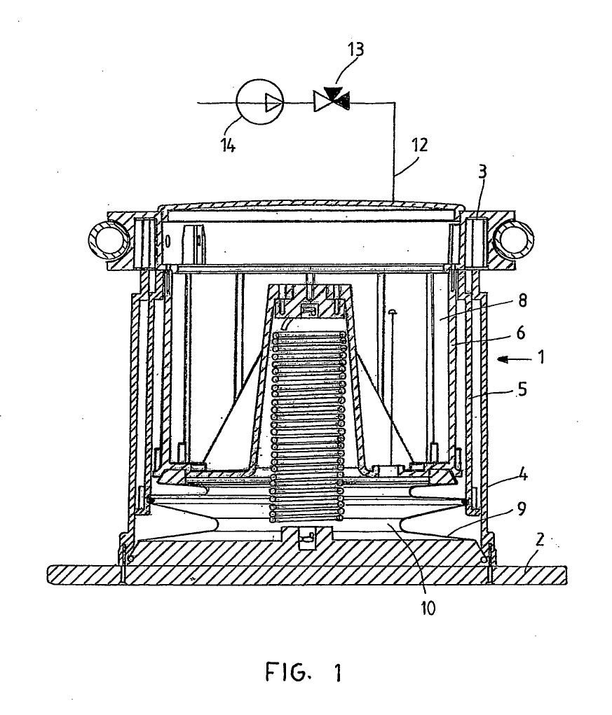

FIG. 1 shows a section in the pressing cylinder according to the invention in its retracted position,

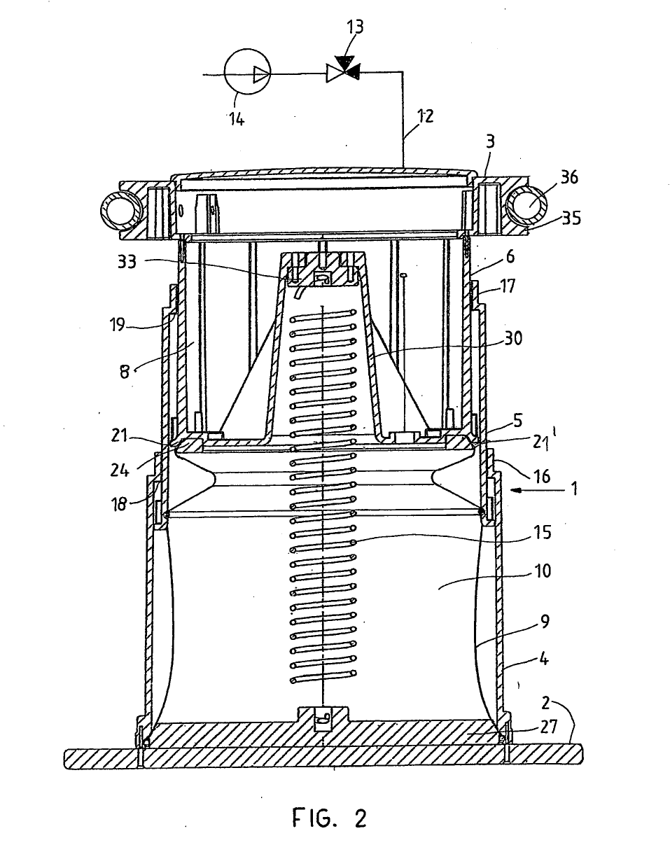

FIG. 2 shows the pressing cylinder in an intermediate position,

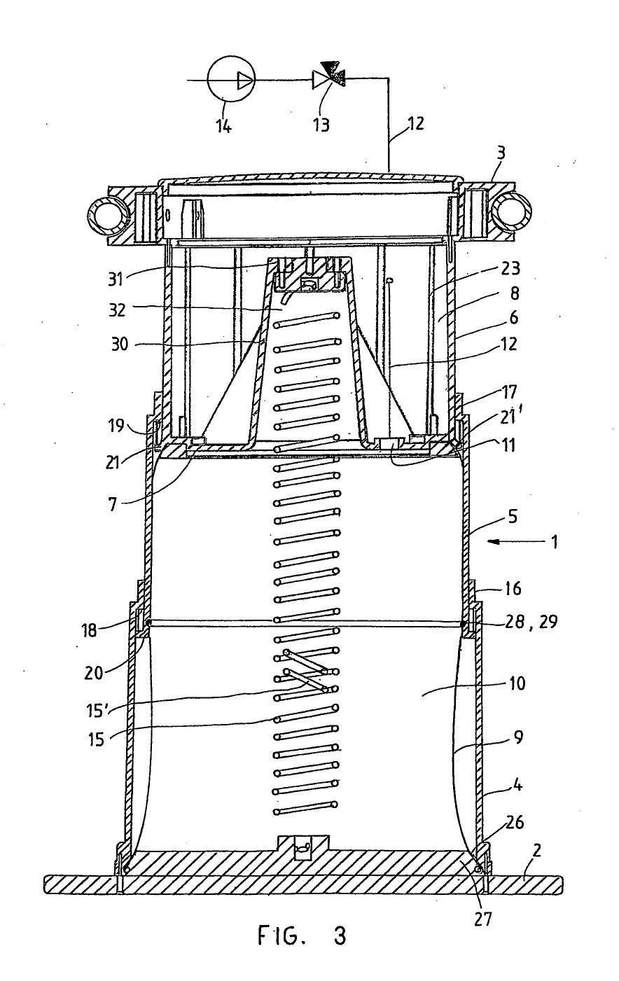

FIG. 3 shows the pressing cylinder in its extended/prolonged position,

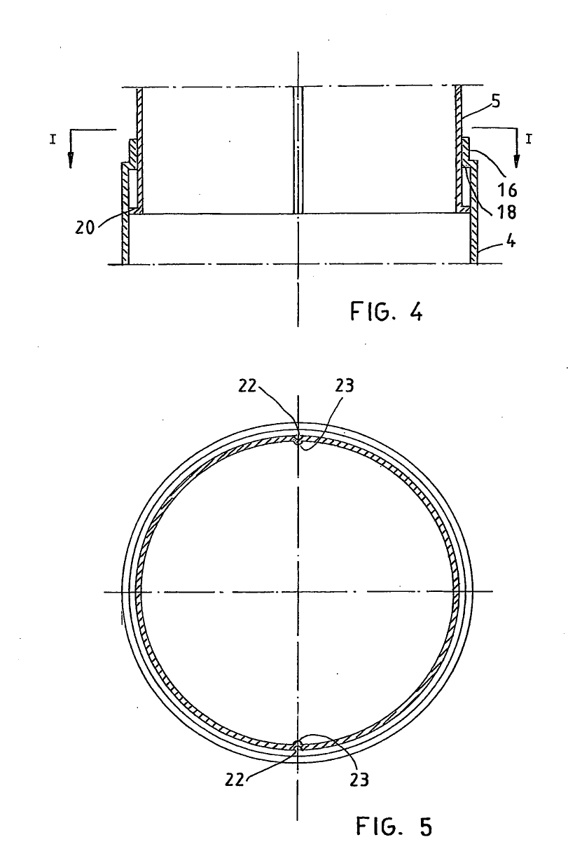

FIG. 4 is a sectional illustration of a cylinder barrel in the first and second cylinder sections,

FIG. 5 shows a section after the line I-I in FIG. 4, and

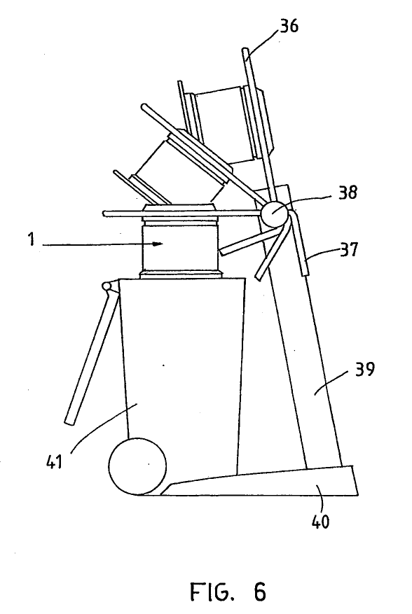

FIG. 6 shows an embodiment of a refuse compressor with a pressing cylinder according to the invention.

As shown, a pressing cylinder 1 is at the bottom coupled to a pressing plate 2 and at the top to a top plate 3, which is fixed to the machine frame. The pressing cylinder is normally vertically oriented and can activate the pressing plate in the upward or downward directions.

As shown, a pressing cylinder according to the invention is composed of a number—preferably three—of cylinder sections, namely a first and bottom cylinder section 4, which at the bottom is fixed to the pressing plate 2, a second and intermediate section 5, which can be displaced telescopically in the longitudinal direction of the cylinder in the first cylinder section, and a third and upper cylinder section 6, which can be displaced telescopically in the second cylinder section. The third cylinder section 6 is at its bottom embodied with a bottom plate 7, which together with the cylinder barrel of the section 6 and the top plate 3 delimits a closed hollow space 8.

Internally in the cylinder—between the periphery of the bottom plate 7 and the cylinder barrel of the cylinder section 4 below at the pressing plate 2—there is an approximately cylinder-shaped flexible diaphragm 9 clamped in the extended position of the cylinder. The diaphragm can be made of rubber. This creates an airtight space 10 inside the cylinder between the bottom plate 7, the pressing plate 2, and the diaphragm 9.

The bottom plate 7 is embodied with a connecting opening 11 for compressed air supplied to the space 10 through a pipe 12 from a three-way valve 13. In an initial position the three-way valve opens for compressed air from a compressor 14. In a second position the three-way valve 13 opens the space 10 to the atmosphere, in which position the cylinder sections 4, 5 and 6 are pulled together by an extension spring 15.

The cylinder barrels in the first and the second cylinder sections 4 and 5 are at the top embodied with a short cylinder-shaped segment, respectively 16 and 17, which have a smaller inner and outer diameter than the cylinder barrels of these cylinder sections. The result is an internal circular ring-shaped collar, respectively 18 and 19. At their bottom the cylinder barrels in the cylinder sections 5 and 6 are embodied with an outward protruding edge, respectively 20 and 21, which can co-operate with the collars 18 and 19, when the pressing cylinder is in its extended position.

The segments 16 and 17 are internally embodied with one or more guiding edges 22, which can have a cross section like a semi-circle and are oriented in the direction of a carrier in the segment. The external side of the cylinder barrels in the sections 5 or 6 are embodied with grooves 23, which are oriented in the direction of a carrier in these sections. These grooves have a cross section, e.g. as a semi-circle, so that they can engage with the guiding edges 22. This prevents that the individual cylinder sections can turn in relation to each other.

As shown, the diaphragm 9 is fixed to the bottom plate 7 in the cylinder section 6 by being clamped between an oblique surface 21′ on the under side of the edge 21 and a surrounding clamping ring 24, which can be accommodated in the bottom plate 7 in a depression in the latter. The diaphragm 9 is fixed to the pressing plate 2 by being clamped between an internal oblique surface at the bottom of the cylinder barrel on the first cylinder section 4 and a clamping plate 27, which is mounted on the upper surface of the pressing plate 2. The diaphragm 9 can furthermore be fixed to the bottom end of the cylinder barrel in the second cylinder section 5 by a clamping ring 28, which engages in a circumferential groove in the cylinder barrel.

As shown, the extension spring can be embodied as two concentric springs 15 and 15′, which have their pitches in mutually opposite directions. A torque which is produced by a turning of the windings in one spring during its movement will be counter-acted by a turning in the opposite direction of the other spring.

As shown, the bottom 7 of the third cylinder section is drawn up into a truncated raised part 30 with a plane top side 31 and an internal hollow space 32, which can approximately take up the spring 15 when the pressing cylinder is in its compressed position. In the bottom of the top side 31 is mounted a clamping member 33, and the top side of the clamping plate 27 is embodied with a clamping member 34. These two clamping members can anchor the ends of the spring 15.

As shown, the top plate 3 can along the outer edge be embodied with a semi-circular cutout 35 which can accommodate a holding organ, for example a pipe clamp 36, which as shown in FIG. 6, is swingably hinged on hinges 38 to a supporting column 39, which is mounted on a foot 40. As the pressing cylinder is very light it can be tilted manually with the pipe clamp by means of a handle 37. In/at the hinges is arranged a retractable locking mechanism, for example a pawl mechanism, which can lock the pipe clamp 36 when it is horizontal and the pressing cylinder 1 is in its active position and in a vertical or approximately vertical position in which the pressing cylinder is not in use, and in which position a refuse container 41 can be placed in/on the foot 39.

The above is only an example of the use of a pressing cylinder according to the invention in a refuse compressor. Such a refuse compressor takes up a minimum of space and can be operated manually.

1. Pressing cylinder (1), preferably for use in a refuse compressor for compression of refuse, which in practical use is preferably oriented vertically, and which at its bottom is coupled to a pressing plate (2) and at the top to a top plate (3) fixed in a frame, and which can activate the pressing plate in its upward and downward directions, characterised by the fact that the pressing cylinder is composed of several, preferably by three, cylinder sections, namely a first and lowest cylinder section (4), which at its bottom is fixed to the pressing plate (2), a second and intermediate section (5), which can be displaced telescopically in the longitudinal direction in/on the first cylinder section (4), and a third and upper cylinder section (6), which at the top is attached to the top plate (3) and which can be displaced telescopically in/on the second cylinder section(5), that the third cylinder section (6) at the bottom is embodied with a bottom plate (7) which together with the cylinder section (6) and the top member (3) delimits a closed hollow space (8) in the cylinder section (6), that between the periphery of the bottom plate (7) and the cylinder barrel of the cylinder section (4) at the bottom at the pressing plate (2) internally in the pressing cylinder is clamped—in the extended position—an approximately cylinder-shaped bendable diaphragm (9), preferably of rubber, whereby internally in the pressing cylinder an airtight space (10) is created between the bottom plate (7), the pressing plate (2) and the diaphragm (9), and that the bottom plate (7) is embodied with an inlet opening (11) for a compression medium, preferably compressed air, that the compressed air is admitted to the space (10) through a pipe (12) from a three-way valve (13), which in a first position opens for compressed air from a compressor (14), and in a second position opens the space (10) to the atmosphere, and that between the bottom plate (7) and the pressing plate (2)—preferably internally in the pressing cylinder—there is clamped an extension spring (15), which can contract the cylinder sections (4,5, 6) at the end of a working stroke.

2. Pressing cylinder according to claim 1, characterised by the fact that the first and the second cylinder sections (4) and (5) in the pressing cylinder at the top are embodied with a short cylinder-shaped segment, respectively (16) and (17), with an inner and outer diameter smaller than those of the cylinder barrel in the cylinder sections, whereby is created an internally circular ring-shaped collar, respectively (18) and (19), which can co-operate with an outwardly directed circumferential edge (20) and (21) at the bottom of respectively the second (5) and the third (6) cylinder sections, when the pressing cylinder is in its extended position.

3. Pressing cylinder according to claim 1, characterised by the fact that the segments (16) and (17) are internally embodied with one or more guiding edges (22), for example with a cross section as part of a circle, which is oriented in the direction of a carrier in the segment, and that the external side of the cylinder barrels in the cylinder sections (5) and (6) are embodied with grooves (23) which are oriented in the direction of a carrier in these sections, and have a cross section so that they can co-operate with the guiding edges (22).

4. Pressing cylinder according to claim 1, characterised by the fact that the diaphragm (9) is attached to the bottom plate (7) in the cylinder section (6) by being securely clamped between a circumferential oblique surface(21′) on the under side of the edge (21) and a clamping ring (24), which can be accommodated in a depression (25) in the bottom plate (7), and to the pressing plate (2) by being securely clamped between an internal oblique surface (26) at the lower end of the cylinder barrel on the first cylinder section (4) and a clamping plate (27), which is mounted on the upper side of the pressing plate (2), and that the diaphragm (9) preferably furthermore is fixed to the lower end of the cylinder barrel on the second cylinder section (5) by a clamping ring (28), which is engaged in a circumferential groove (29) on the internal side of the cylinder barrel of the section.

5. Pressing cylinder according to claim 1, characterised by the fact that the extension spring (15) is embodied as a double spring consisting of two concentric springs (15,15′) with oppositely directed pitches.

6. Pressing cylinder according to claim 1, characterised by the fact that the bottom (7) at its middle is drawn up into a raised part (30) of the shape of a truncated cone with a plane top surface (31) and an internal hollow space (32).
which can accommodate the spring (15), when the pressing cylinder is in its compressed state, and that in the bottom of the top side (31) and on the top side of the clamping plate (27) is mounted a clamping member, respectively (33) and (34) for attachment of the two ends of the springs (15,15′).
